(19) United States
(12) Patent Application Publication
(10) Pub. No.: US 2025/0035749 A1
(43) Pub. Date: Jan. 30, 2025

(54) METHOD AND APPARATUS FOR PROCESSING DETECTION RESULT, AND COMPUTER-READABLE STORAGE MEDIUM

(71) Applicant: HESAI TECHNOLOGY CO., LTD., Shanghai (CN)

(72) Inventors: Hongyan ZHANG, Shanghai (CN); Ruiwan CAI, Shanghai (CN); Shaoqing XIANG, Shanghai (CN)

(21) Appl. No.: 18/913,812

(22) Filed: Oct. 11, 2024

Related U.S. Application Data
(63) Continuation of application No. PCT/CN2022/120478, filed on Sep. 22, 2022.

(30) Foreign Application Priority Data
Apr. 13, 2022 (CN) 202210385823.5

(51) Int. Cl. G01S 7/48

(52) U.S. Cl. CPC G01S 7/4802

(57) ABSTRACT

A method for processing detection result includes determining a signal peak of a target pixel signal, and determining an accumulated signal by accumulating the target pixel signal based on a determination that the target pixel signal and neighboring pixel signals satisfy an accumulation condition and the signal peak of the target pixel signal is not greater than a first detection threshold.

### CROSS-REFERENCE TO RELATED APPLICATIONS

This application is a continuation of PCT Application No. PCT/CN2022/120478, filed on Sep. 22, 2022, which claims priority to Chinese Patent Application No. 202210385823.5, filed on Apr. 13, 2022. The disclosures of the aforementioned applications are hereby incorporated by reference in their entireties.

### TECHNICAL FIELD

This disclosure relates to the technical field of LiDAR detection, and in particular, to methods and apparatuses for processing detection result, and computer-readable storage media.

### BACKGROUND

To improve measurement range performance, a neighborhood accumulation method can be used for processing a detection result of a LiDAR. When strength of an echo signal of a remote object (e.g., target object, obstacle, or the like) is low, the echo signal of a pixel point can be lower than a detection threshold. Signals of several neighboring pixel points can be accumulated, the accumulated result can exceed the detection threshold. The object can be detected. The measurement range performance of the LiDAR can be improved.

How to improve detection accuracy in the neighborhood accumulation method is a challenge.

### SUMMARY

In a first aspect, this disclosure provides a method for processing detection result. The method includes determining a signal peak of a target pixel signal; and determining an accumulated signal by accumulating the target pixel signal and the neighboring pixel signals, based on a determination that the target pixel signal and a neighboring pixel signal satisfy an accumulation condition and the signal peak of the target pixel signal is not greater than a first detection threshold.

Optionally, the target pixel signal and the neighboring pixel signals satisfy the accumulation condition includes: a peak value of the target pixel signal is less than a first accumulation threshold, and a signal peak of the neighboring pixel signal is less than a second accumulation threshold; and a neighboring pixel is a pixel adjacent in angle to a target pixel, or a pixel adjacent in channel to the target pixel.

Optionally, the first accumulation threshold is configured to be a predetermined first constant value, or the first accumulation threshold is configured be determined based on the target pixel signal; and the second accumulation threshold is configured to be a predetermined second constant value, or the second accumulation threshold is configured to be determined based on the target pixel signal.

Optionally, the first accumulation threshold or the second accumulation threshold is configured to be determined based on the following steps: determining a first clamped signal by clamping the target pixel signal; determining a mean value un and a standard deviation on of the first clamped signal; determining the first accumulation threshold as μₙ+y₁σₙ; and determining the second accumulation threshold as μₙ+y₂σn, and y₁≤y₂.

Optionally, the clamping the target pixel signal includes: comparing a signal amplitude of the target pixel signal at each time stamp with a predetermined clamp value, and selecting a minimum value between the signal amplitude at each time stamp and the predetermined clamp value. The minimum value corresponding to the time stamp is configured to a signal amplitude of the first clamped signal on the corresponding time stamp.

Optionally, the detection result processing method further includes: based on a determination that the signal peak is greater than the first detection threshold, determining the target pixel signal as a detection result corresponding to a target pixel.

Optionally, the first detection threshold is configured to be a predetermined third constant value, or the first detection threshold is configured to be determined based on the target pixel signal.

Optionally, the first detection threshold is configured to be determined based on the following steps: determining a first clamped signal by clamping the target pixel signal; determining a mean value Un and a standard deviation on of the first clamped signal; and determining the first detection threshold to be μₙ+Xσₙ.

Optionally, when determined the accumulated signal, the method further includes: when detecting the accumulated signal satisfying a predetermined output condition, determining the accumulated signal as a detection result corresponding to a target pixel.

Optionally, a neighboring pixel includes a first neighboring pixel and a second neighboring pixel; and the accumulated signal includes a first accumulated signal determined by accumulating the target pixel signal and a first neighboring pixel signal, a second accumulated signal determined by accumulating the target pixel signal and a second neighboring pixel signal, and a third accumulated signal determined by accumulating the target pixel signal, the first neighboring pixel signal, and the second neighboring pixel signal. When detecting the accumulated signal satisfying the predetermined output condition, determining the accumulated signal as the detection result corresponding to the target pixel includes: determining the accumulated signals satisfying the output condition as detection result corresponding to the target pixel when detecting any one of the first accumulated signal, the second accumulated signal, and the third accumulated signal satisfying the output condition.

Optionally, when detecting the accumulated signal satisfying the predetermined output condition, determining the accumulated signal as the detection result corresponding to the target pixel includes: when detecting multiple of the first accumulated signal, the second accumulated signal, and the third accumulated signal satisfy the output condition, selecting the one with the highest peak value among the first accumulated signal, the second accumulated signal, and the third accumulated signal as the detection result corresponding to the target pixel.

Optionally, the output condition includes: a peak value of the accumulated signal is greater than a second detection threshold.

Optionally, the output condition includes: a peak value of the accumulated signal is greater than a second detection threshold.

Optionally, the second detection threshold is configured to be determined based on the following steps: determining a second clamped signal by clamping the accumulated signal; determining a mean value μ₂ and a standard deviation σ₂ of the second clamped signal; and determining the second detection threshold to be μ₂+xσ₂.

Optionally, neighboring pixels include a first neighboring pixel and a second neighboring pixel; and the second detection threshold is configured to be determined based on the following steps: determining a third clamped signal by clamping the first neighboring pixel signal, and determining a fourth clamped signal by clamping the second neighboring pixel signal; determining a mean value μₙ₋₁ and a standard deviation σₙ₋₁ of the third clamped signal and a mean value μₙ₋₂ and a standard deviation σₙ₋₂ of the fourth clamped signal; and determining the second detection threshold to be μ₂+xσ₂, where μ₂=(μₙ₋₁+μₙ₊₁)/2, and σ₂=\sqrt{varₙ₋₁+Varₙ₊₁}÷2.

Optionally, neighboring pixels include a first neighboring pixel and a second neighboring pixel; and the second detection threshold is configured to be determined based on the following steps: determining a first clamped signal by clamping the target pixel signal, determining a third clamped signal by clamping the first neighboring pixel signal, and determining a fourth clamped signal by clamping the second neighboring pixel signal; determining a mean value μₙ and a standard deviation on of the first clamped signal, and determining a mean value μₙ₋₁, a standard deviation σₙ₋₁, and a variance varₙ₋₁ of the third clamped signal, and a mean value μₙ₊₁, a standard deviation σₙ₊₁, and a variance varₙ₊₁ of the fourth clamped signal; and determining the second detection threshold to be μ₂+xσ₂, where μ₂=(μₙ₋₁+μₙ+μₙ₊₁)/3, and σ₂=\sqrt{varₙ₋₁+varₙ+varₙ₊₁}÷3.

In a second aspect, this disclosure provides a computer-readable storage medium. The computer-readable storage medium is configured to be a non-volatile storage medium or a non-transient storage medium and stores a computer program. The computer program is configured to execute steps of the method for processing detection result described in any one of the above when executed by a processor.

In a third aspect, this disclosure provides an apparatus for processing detection result. The apparatus includes a memory and a processor. The memory stores a computer program executable on the processor. The processor is configured to execute steps of the method for processing detection result described in any of the above when executing the computer program.

In some embodiments, the signal peak of the target pixel signal can be determined.

Based on a determination that the target pixel signal and the neighboring pixel signals satisfy the accumulation condition and the signal peak of the target pixel signal is not greater than the first detection threshold, the accumulated signal can be determined by accumulating the target pixel signal and the neighboring pixel signals. When the accumulated signal is determined, the accumulated signal can be determined as the detection result corresponding to the target pixel. Based on a determination that the target pixel signal and the neighboring pixel signals satisfy the accumulation condition and the signal peak of the target pixel signal is low, the accumulated signal can be determined. In such a case, ranging deviations caused by neighborhood accumulation can be reduced and detection accuracy can be improved accordingly.

### BRIEF DESCRIPTION OF THE DRAWINGS

FIG. 1 shows a schematic diagram of an example pixel distribution, consistent with some embodiments of this disclosure.

FIG. 2 shows a schematic diagram of a detection result waveform determined based on an existing neighborhood accumulation method, a target pixel waveform, and a neighboring pixel point waveform.

FIG. 3 shows a flowchart of an example method for processing detection result, consistent with some embodiments of this disclosure.

FIG. 4 shows a diagram of waveform of an example target pixel signal, consistent with some embodiments of this disclosure.

FIG. 5 shows a diagram of waveform of an example clamped signal, consistent with some embodiments of this disclosure.

FIG. 6 to FIG. 10 show schematic diagrams of waveform of several example application scenarios, consistent with some embodiments of this disclosure.

FIG. 11 shows a schematic structural diagram of an example apparatus for processing detection result, consistent with some embodiments of this disclosure.

### DETAILED DESCRIPTION

A LiDAR can include multiple laser emitters and multiple detectors. The multiple laser emitters can be arranged in a specified direction (e.g., a vertical direction of the LiDAR). Each laser emitter can emit a detection signal outwardly with a different angle relative to the specified direction. The detector has a correspondence relationship with the laser emitter. The detector can receive an echo signal of the detection signal reflected back to the LiDAR by an object. When the detector receives the echo signal, a distance to the object can be determined based on a time difference (e.g., time of flight) between the detection signal of the corresponding laser emitter and the echo signal received by the detector.

The multiple detectors can be arranged along the vertical direction of the LiDAR. Different detectors can receive the echo signals at different vertical angles. In such a case, vertical angles corresponding to data points measured by different detectors can be determined based on detector positions. In another aspect, the multiple laser emitters and the multiple detectors can rotate with a rotor of the LiDAR in a horizontal direction, or the detection signal can be deflected to different horizontal directions by a scanning mirror (e.g., a one dimensional or two-dimensional scanning mirror, such as a rotating mirror, a vibration mirror, or the like), or the laser emitters and the detectors can be arranged in a two-dimensional array, and detectors at different positions in the horizontal direction can receive the echo signals from different horizontal angles. In such a case, the two-dimensional scanning of the LiDAR can be achieved.

The detector and the laser emitter having a correspondence relationship can form a detection channel. A detection channel can form a pixel point in a two-dimensional point cloud of the LiDAR based on detection data of a horizontal angle.

FIG. 1 shows a schematic diagram of an example pixel distribution, consistent with some embodiments of this disclosure. With reference to FIG. 1, a target pixel can be set as a pixel point with channel ch(i) and angle θₙ. In some embodiments, neighboring pixel points of the target pixel can be a pixel point with channel ch(i) and angle θₙ₋₁, and a pixel point with channel ch(i) and angle θₙ₊₁. In some embodiments, neighboring pixel points of the target pixel can be a pixel point with channel ch (i−1) and angle θ, and a pixel point with channel ch (i+1) and angle θₙ.

In some existing neighborhood accumulation methods, signals of several pixel points can be accumulated, or accumulated results can be averaged. For example, signals of the target pixel and the neighboring pixel points (e.g., the pixel point with channel ch(i) and angle θₙ₋₁, and the pixel point with channel ch(i) and angle θₙ₊₁) can be accumulated. And an accumulated result or a result of averaging the accumulated result can be determined as a detection result of the target pixel and the neighboring pixel points. However, reduce detection accuracy can be reduced in these existing neighborhood accumulation methods.

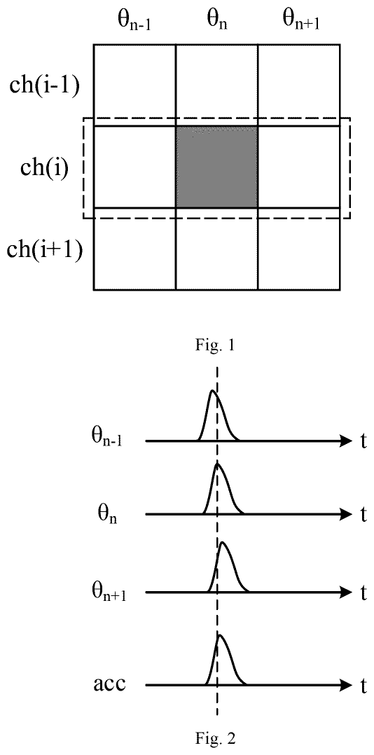

FIG. 2 shows a schematic diagram of a detection result waveform determined based on an existing neighborhood accumulation method, a target pixel waveform, and a neighboring pixel point waveform. With reference to FIG. 2, the neighboring pixel points are a pixel point with channel ch(i) and angle θₙ₋₁, and a pixel point with channel ch(i) and angle θₙ₊₁. Detection time of different pixel points can be different. The channel ch(i) detects the angles θₙ₋₁, On, and θₙ₋₁ sequentially. Even if a same object is measured at three angles, due to time delay, there is a difference in time of flight (e.g., peak time of the angles θₙ₋₁, θₙ, and θₙ₊₁ shown in FIG. 2) corresponding to echo signals of three pixel points. It can be seen from FIG. 2 that, if waveforms of the three pixel points are accumulated directly, there is a difference between a peak value of a finally-outputted detection result acc and a peak value of the detection result corresponding to the target pixel. In such a case, a reduction in detection accuracy can be resulted in.

In some embodiments, a signal peak of a target pixel signal can be determined. Based on a determination that the target pixel signal and neighboring pixel signals satisfy an accumulation condition and the signal peak of the target pixel signal is not greater than a first detection threshold, an accumulated signal can be determined by accumulating the target pixel signal and the neighboring pixel signals. The accumulated signal can be determined as the detection result corresponding to the target pixel. Based on a determination that the target pixel signal and the neighboring pixel signals satisfy the accumulation condition and the signal peak of the target pixel signal is low, the accumulated signal can be determined. In such a case, ranging deviations caused by neighborhood accumulation can be reduced. Detection accuracy can be improved accordingly.

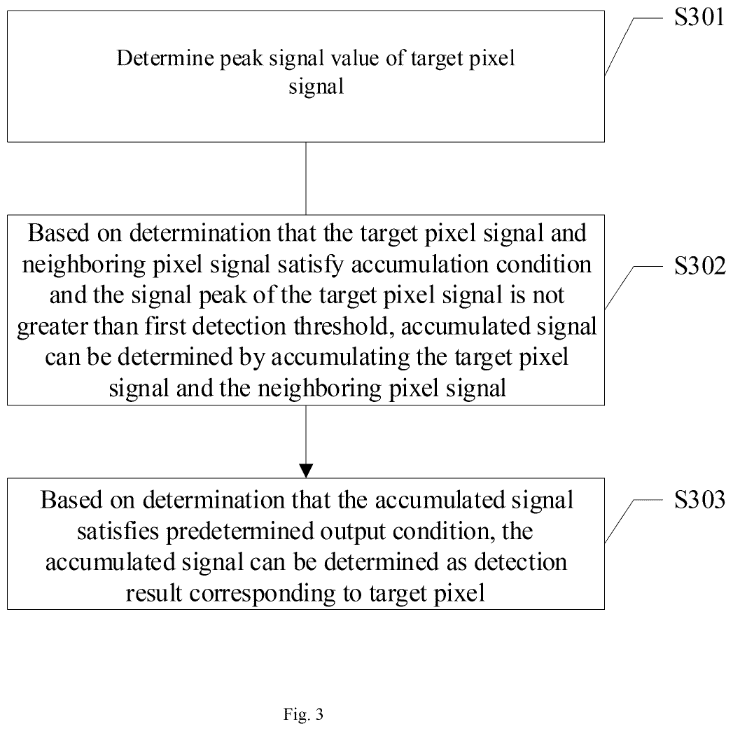

This disclosure provides a method for processing detection result. With reference to FIG. 3, the method includes the following steps.

At S301, a signal peak of a target pixel signal can be determined.

In some embodiments, still with reference to FIG. 1, a target pixel can be the pixel point with channel ch(i) and angle θₙ. When the target pixel signal is determined, the signal peak corresponding to the target pixel signal can be determined. The signal peak corresponding to the target pixel signal can be a peak value of a voltage amplitude corresponding to the target pixel signal.

When the signal peak of the target pixel signal is determined, the signal peak of the target pixel signal can be compared with a first detection threshold. Based on a determination that the signal peak of the target pixel signal is not greater than the first detection threshold, S302 can be executed.

At S302, based on a determination that the target pixel signal and neighboring pixel signals satisfy an accumulation condition and the signal peak of the target pixel signal is not greater than a first detection threshold, an accumulated signal can be determined by accumulating the target pixel signal and the neighboring pixel signals.

In some embodiments, a neighboring pixel can be a pixel adjacent in channel to the target pixel, or a pixel adjacent in angle to the target pixel.

Still with reference to FIG. 1, the neighboring pixel can include at least one of a first neighboring pixel or a second neighboring pixel. In some embodiments, the first neighboring pixel is the pixel point with channel ch(i) and angle θₙ₋₁, and the second neighboring pixel is the pixel point with channel being ch(i) and angle θₙ₊₁. In some embodiments, the first neighboring pixel is the pixel point with channel ch (i−1) and angle θₙ, and the second neighboring pixel is the pixel point with channel ch (i+1) and angle θₙ. The two manners of selecting the neighboring pixels do not affect the solutions of this disclosure.

In some embodiments, the target pixel signal and the neighboring pixel signals satisfy the accumulation condition includes: a peak value of the target pixel signal is less than a first accumulation threshold, and a signal peak of the neighboring pixel signal is less than a second accumulation threshold.

In some embodiments, the signal peak of the neighboring pixel signals is less than the second accumulation threshold includes: a signal peak of a first neighboring pixel signal is less than the second accumulation threshold; or, a signal peak of a second neighboring pixel signal is less than the second accumulation threshold; or, the signal peak of the first neighboring pixel signal is less than the second accumulation threshold, and the signal peak of the second neighboring pixel signal is less than the second accumulation threshold.

In some embodiments, the first accumulation threshold can be a predetermined first constant value, and the first accumulation threshold can also be determined based on the target pixel signal. The second accumulation threshold can be a predetermined second constant value, and the second accumulation threshold can also be determined based on the target pixel signal.

The method for processing detection result can be initiated by a controller, a processor, or the like. For example, the controller can send an initiating signal to control an apparatus to initiate processing detection result, based on the initiating signal. For example, the LiDAR can include a detector. A processor in the LiDAR can initiate processing detection result when the detector receives an echo.

The example process of determining the first accumulation threshold and the second accumulation threshold using the target pixel signal is described below.

In some embodiments, a first clamped signal can be determined by clamping the target pixel signal. A mean value μₙ and a standard deviation value on of the first clamped signal can be determined. The first accumulation threshold can be determined as μₙ+y₁σₙ. The second accumulation threshold can be determined as μₙ+y₂ρₙ.

In some embodiments, y₁≤y₂. In some embodiments, y₁<y₂.

In some embodiments, the first clamped signal corresponding to the target pixel signal can be determined based on the following step. A signal amplitude of the target pixel signal at each time stamp can be compared with a predetermined clamp value. A minimum value between the signal amplitude at each time stamp and the predetermined clamp value can be selected. The minimum value corresponding to the time stamp can be the signal amplitude of the first clamped signal at the corresponding time stamp.

In some embodiments, the time stamp can be a sampling time point. At each time stamp, the signal amplitude at the time stamp can be compared with the predetermined clamp value. When the signal amplitude at the time stamp is greater than the predetermined clamp value, the predetermined clamp value can be determined as the signal amplitude of the first clamped signal at the time stamp. When the signal amplitude at the time stamp is not greater than the predetermined clamped value, the signal amplitude of the target pixel signal at the time stamp can be determined as the signal amplitude of the first clamped signal on the time stamp.

For example, a time stamp 1 corresponding to a sampling point 1. The signal amplitude of the target pixel signal at the time stamp 1 can be Sₜ₁. The predetermined clamp value can be ai, and Sₜ₁>ai. In such a case, the signal amplitude of the first clamped signal at the time stamp 1 can be the predetermined clamp value ai. A time stamp 2 corresponding to a sampling point 2. The signal amplitude of the target pixel signal at the time stamp 2 can be Sₜ₂. The predetermined clamp value can be ai, and Sₜ₂<ai. In such a case, the signal amplitude of the first clamped signal on the time stamp 2 can be Sₜ₂.

The signal amplitudes at all time stamps can be determined in a similar or the same way to determine the first clamped signal.

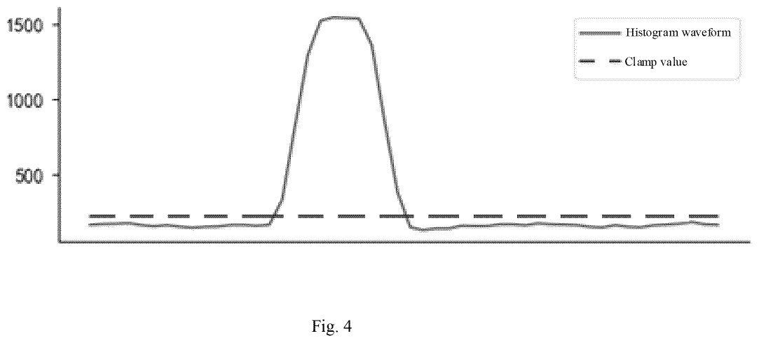

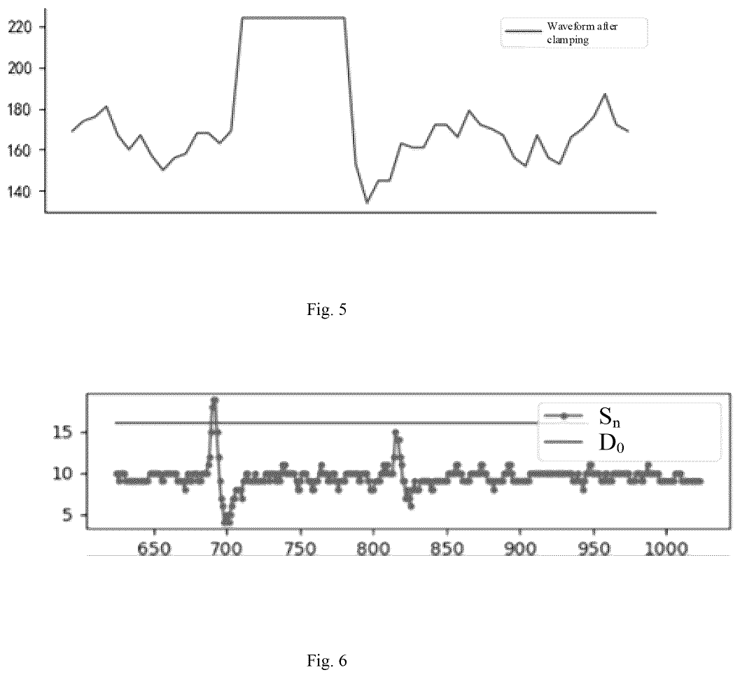

FIG. 4 shows a diagram of waveform of an example target pixel signal, consistent with some embodiments of this disclosure. FIG. 5 shows a diagram of waveform of an example clamped signal, consistent with some embodiments of this disclosure.

In some embodiments, when the accumulated signal is determined, S303 can also be executed.

At S303, based on a determination that the accumulated signal satisfies a predetermined output condition, the accumulated signal can be determined as a detection result corresponding to a target pixel.

In some embodiments, neighboring pixels of the target pixel can include a first neighboring pixel and a second neighboring pixel. The accumulated signal can include a first accumulated signal, a second accumulated signal, and a third accumulated signal. The first accumulated signal is determined by accumulating the target pixel signal and a first neighboring pixel signal. The second accumulated signal is determined by accumulating the target pixel signal and a second neighboring pixel signal. The third accumulated signal is determined by accumulating the target pixel signal, the first neighboring pixel signal, and the second neighboring pixel signal.

There can be the first accumulated signal, second accumulated signal, and third accumulated signal. In such a case, when detecting whether the accumulated signal satisfies a predetermined condition, whether any one of the first accumulated signal, second accumulated signal, and third accumulated signal satisfies the output condition can be respectively detected. Based on a determination that any one of the first accumulated signal, second accumulated signal, and third accumulated signal satisfies the output condition, the accumulated signals satisfying the output condition can be determined as the detection result corresponding to the target pixel.

When at least two of the first accumulated signal, second accumulated signal, and third accumulated signal satisfy the output condition, the one with the highest peak value among the accumulated signals satisfying the output condition can be determined as the detection result corresponding to the target pixel.

For example, based on a determination that only the first accumulated signal among the first accumulated signal, second accumulated signal, and third accumulated signal satisfies the output condition, the first accumulated signal can be determined as the detection result corresponding to the target pixel.

For another example, based on a determination that both the first accumulated signal and the second accumulated signal among the first accumulated signal, second accumulated signal, and third accumulated signal satisfy the output condition, and the peak value of the first accumulated signal is greater than the peak value of the second accumulated signal, the first accumulated signal can be determined as the detection result corresponding to the target pixel.

In some embodiments of this disclosure, when at least two of the first accumulated signal, second accumulated signal, and third accumulated signal satisfy the output condition, the detection result corresponding to the target pixel can also be determined based on priorities among the accumulated signals.

For example, when the priorities of the first accumulated signal and second accumulated signal can be set to be higher than that of the third accumulated signal, the first accumulated signal or the second accumulated signal can be determined as the detection result corresponding to the target pixel when the third accumulated signal and either or both of the first accumulated signal and the second accumulated signal satisfy the output condition. In the embodiments of this disclosure, the number of accumulated pixels in the output accumulated signals can be minimized. In such a case, the impact of the accumulation of different pixel points on detection accuracy can be reduced.

It can be understood by those skilled in the art that, the accumulation of two signals can be an accumulation between amplitudes corresponding to the two signals.

In some embodiments of this disclosure, the first accumulated signal, second accumulated signal, and third accumulated signal can all be normalized. Specifically, the first accumulated signal can be an average value of the target pixel signal and the first neighboring pixel signal. The second accumulated signal can be an average value of the target pixel signal and the second neighboring pixel signal. The third accumulated signal can be an average value of the target pixel signal, the first neighboring pixel signal, and a second neighboring pixel signal.

In some embodiments, the accumulated signal satisfies the output condition includes: the peak value of the accumulated signal is greater than a second detection threshold.

In some embodiments, the second detection threshold can be a predetermined third constant value. The second detection threshold can also be determined based on the accumulated signal.

The example process of determining the second detection threshold based on the accumulated signal is described below.

A second clamped signal can be determined by clamping the accumulated signal. The process of clamping the accumulated signal can correspondingly follow the example process of clamping the target pixel signal, and are not described herein again.

When the second clamped signal is determined, a mean value μ₂ and a standard deviation value σ₂ of the second clamped signal can be determined. The second detection threshold can be determined as μ₂+xσ₂. The value of x can be related to a noise rate. The value of x can be small when the noise rate is high. Conversely, the value of x can be large when the noise rate is low. The value of x can range from 5 to 6.

In some embodiments, clamping the accumulated signal includes clamping of any one of the first accumulated signal, second accumulated signal, and third accumulated signal, ultimately determining a second detection threshold. The second detection threshold can be determined based on any one of the first accumulated signal, second accumulated signal, and third accumulated signal. In such a case, the accumulated signal satisfies the predetermined output condition includes: at least one of the first accumulated signal, second accumulated signal, and third accumulated signal is greater than the determined second detection threshold.

In some embodiments, clamping the accumulated signal includes clamping the first accumulated signal, the second accumulated signal, and the third accumulated signal, respectively. A second detection threshold Dₐ₁ corresponding to the first accumulated signal, a second detection threshold Dₐ₂ corresponding to the second accumulated signal, and a second detection threshold Dₐ₃ corresponding to the third accumulated signal can be determined based on the above operations. In such a case, the output conditions corresponding to different accumulated signals can be different. For example, that the accumulated signal satisfies the output condition includes: the peak value of the first accumulated signal is greater than the second detection threshold Dₐ₂, or the peak value of the second accumulated signal is greater than the second detection threshold Dₐ₁, or the peak value of the third accumulated signal is greater than the second detection threshold Dₐ₃.

In some embodiments, a third clamped signal can be determined by clamping the first neighboring pixel signal, and a mean value μₙ₋₁ and a standard deviation θₙ₋₁ of the third clamped signal can be determined by calculation. A fourth clamped signal can be determined by clamping the second neighboring pixel signal. A mean value μₙ₋₂ and a standard deviation σₙ₋₂ of the fourth clamped signal can be calculated. The second detection threshold can be determined as μ₂+xσ₂. Among them, μ₂=(μₙ₋₁+μₙ₊₁)/2, and σ₂=\sqrt{varₙ₋₁+Varₙ₊₁}÷₂, where var is variance.

In some embodiments, the first clamped signal can be determined by clamping the target pixel signal. The mean value μₙ and standard deviation σₙ of the first clamped signal can be calculated. The third clamped signal can be determined by clamping the first neighboring pixel signal. The mean value μₙ₋₁, standard deviation σₙ₋₁, and variance varₙ₋₁ of the third clamped signal can be determined by calculation. The fourth clamped signal can be determined by clamping the second neighboring pixel signal. The mean value μₙ₊₁, standard deviation σₙ₊₁, and variance varₙ₊₁ of the fourth clamped signal can be calculated. The second detection threshold can be determined as ρ₂+xσ₂. Among them, μ₂=(μₙ₋₁+μₙ+μₙ₊₁)/3, and σ₂=\sqrt{varₙ₋₁+varₙ+varₙ₊₁}÷3.

In some embodiments of this disclosure, different pixels of a LiDAR (e.g., each pixel of a LiDAR) can be sequentially treated as a target pixel, and detection result can be processed sequentially through the above steps S301-S303. In such a case, the first neighboring pixel and the second neighboring pixel can be treated as the target pixels in other detection result processing steps. Signals can be clamped. Mean values, variances, and standard deviations can be counted to determine the corresponding first detection threshold. Furthermore, in the step of processing detection result of the target pixel, the second detection threshold can be determined based on the mean values and standard deviations or based on the mean values, variances, and standard deviations. Data determined in other steps of processing detection result of the first neighboring pixel and the second neighboring pixel can be used, without counting accumulated results. In such a case, the calculation amount of the second detection threshold and system power consumption can be reduced.

In some embodiments, based on a determination that the signal peak corresponding to the target pixel signal is greater than the first detection threshold, the target pixel signal can be determined as the detection result corresponding to the target pixel.

In some embodiments, when the detection result corresponding to the target pixel is determined through steps S301-S303, time of flight can be determined based on the detection result corresponding to the target pixel. An object distance can be calculated. A reflectivity of object can be calculated based on information reflecting an echo intensity such as a peak amplitude, a leading edge slope, an area covered by a signal pulse, or the like corresponding to the detection result.

FIG. 6 to FIG. 10 show schematic diagrams of waveforms of several example application scenarios, consistent with some embodiments of this disclosure.

In some embodiments, with reference to FIG. 6, the peak amplitude of the target pixel signal Sₙ reaches the first detection threshold D₀. In such a case, the target pixel signal Sₙ can be directly determined as the detection result of the target pixel without considering whether the waveform of the neighboring pixel signal reaches the first detection threshold D₀ or other conditions.

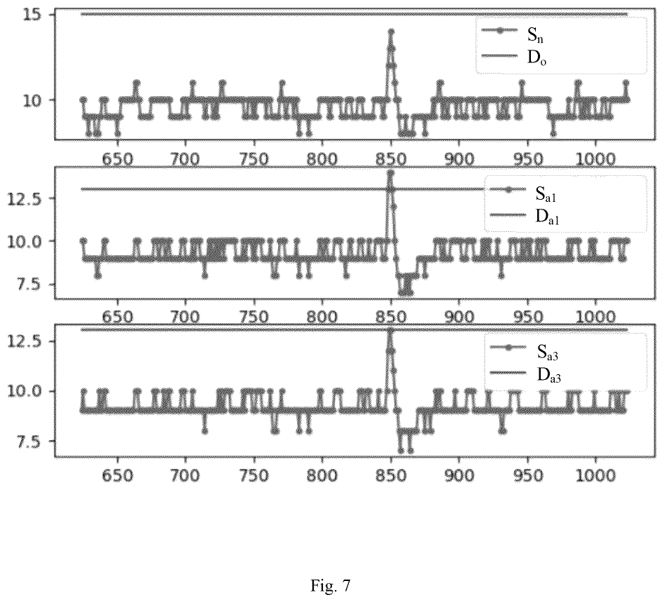

In some embodiments, with reference to FIG. 7, the peak amplitude of the target pixel signal Sₙ does not reach the first detection threshold D₀. Because the peak amplitude of the target pixel signal Sₙ does not reach the first detection threshold D₀, whether the target pixel signal Sₙ and other neighboring pixel signals (Sₙ₋₁ or Sₙ₊₁) satisfy the accumulation condition can be further determined.

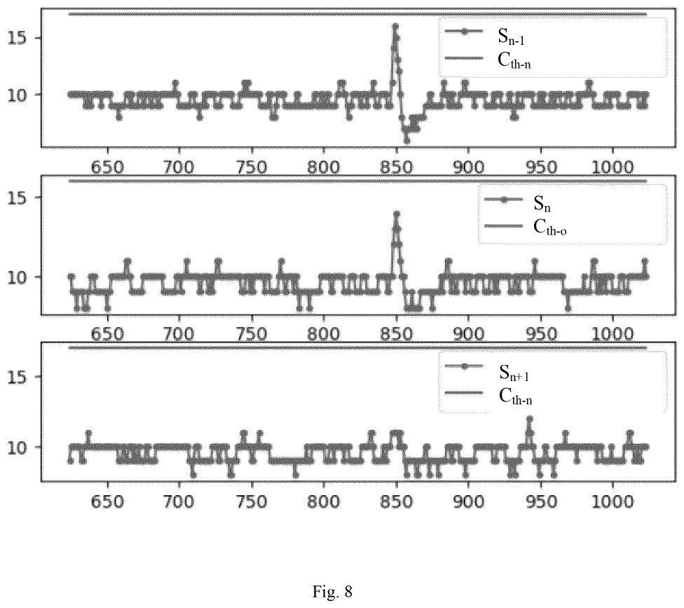

With reference to FIG. 8, the peak amplitude of the target pixel signal Sₙ is less than a first accumulation threshold Cₜₕ₋₀, and peak amplitudes of the neighboring pixel signals Sₙ₋₁ and Sₙ₊₁ are both less than a second accumulation threshold Cₜₕ₋ₙ. In such a case, the target pixel signal Sₙ and the neighboring pixel signals Sₙ₋₁ and Sₙ₊₁ can be determined to satisfy the accumulation condition.

Still with reference to FIG. 7, whether the accumulated signal satisfies the output condition can be further determined. The signal peak of the first accumulated signal Sₐ₁ determined by accumulating the target pixel signal Sₙ and the neighboring pixel signal Sₙ₋₁ reaches the second detection threshold Dₐ₁. The signal peak of the third accumulated signal Sₐ₃ determined by accumulating the target pixel signal Sₙ and the neighboring pixel signals Sₙ₋₁ and Sₙ₊₁ reaches the third detection threshold Dₐ₃. In such a case, the first accumulated signal Sₐ₁ and the third accumulated signal Sₐ₃ satisfy the output condition.

In some embodiments, the accumulated signal with a higher peak amplitude can be selected from the first accumulated signal Sₐ₁ and the third accumulated signal Sₐ₃. The first accumulated signal Sₐ₁ can be determined as the detection result of the target pixel.

In some embodiments, based on the priority of the accumulated signal, when the priority of the first accumulated signal is higher than that of the third accumulated signal, the first accumulated signal Sₐ₁ can be determined as the detection result of the target pixel.

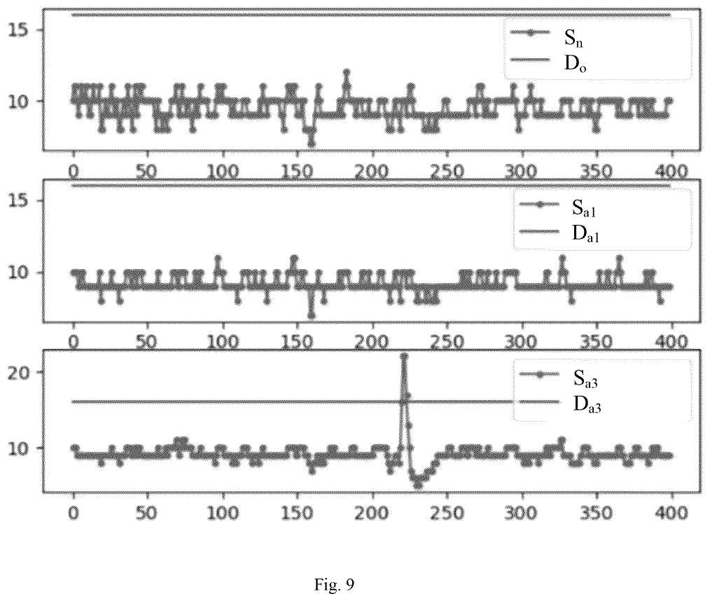

In some embodiments, with reference to FIG. 9, the peak amplitude of the target pixel signal Sₙ does not reach the first detection threshold D₀. Because the peak amplitude of the target pixel signal Sₙ does not reach the first detection threshold D₀, whether the target pixel signal Sₙ and other neighboring pixel signals (Sₙ₋₁ or Sₙ₋₁) satisfy the accumulation condition can be further determined.

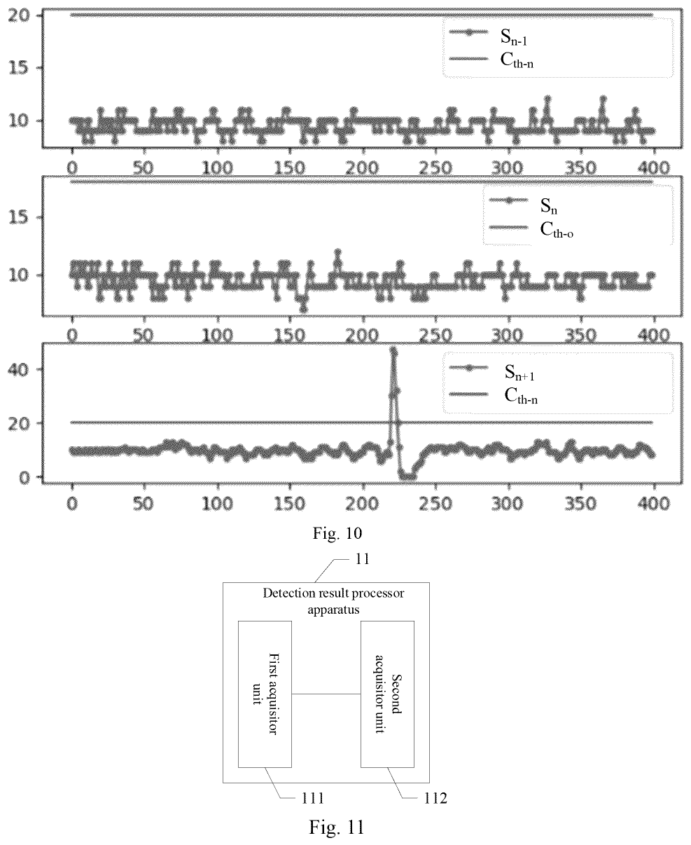

With reference to FIG. 10, the peak amplitude of the target pixel signal Sₙ is less than the first accumulation threshold Cₜₕ₋₀, the peak amplitude of the neighboring pixel signal Sₙ₋₁ is less than the second accumulation threshold Cₜₕ₋ₙ, but the peak amplitude of the neighboring pixel signal Sₙ₊₁ exceeds the second accumulation threshold Cₜₕ₋ₙ. In such a case, the target pixel signal Sₙ and the neighboring pixel signal Sₙ₋₁ can be determined to satisfy the accumulation condition. The neighboring pixel signal Sₙ₊₁ can be determined not to satisfy the accumulation condition.

Still with reference to FIG. 9, the signal peak of the first accumulated signal Sₐ₁ determined by accumulating the target pixel signal Sₙ and the neighboring pixel signal Sₙ₋₁ does not reach the second detection threshold Dₐ₁, and does not satisfy the output condition. Even if the signal peak of the third accumulated signal Sₐ₃ determined by accumulating the target pixel signal Sₙ and the neighboring pixel signals Sₙ₋₁ and Sₙ₊₁ reaches the third detection threshold Dₐ₃, because the neighboring pixel signal Sₙ₊₁ does not satisfy the accumulation condition, it is beneficial to discard the third accumulated signal Sₐ₃. In such a case, it can be determined that the target pixel does not have a qualified waveform. No valid signal is outputted.

It should be noted that, in the above embodiments, the first accumulated signal Sₐ₁ can be determined by accumulating the target pixel signal Sₙ and the neighboring pixel signal Sₙ₋₁. The third accumulated signal Sₐ₃ can be determined by accumulating the target pixel signal Sₙ and the neighboring pixel signals Sₙ₋₁ and Sₙ₊₁. The first accumulated signal Sₐ₁ and the third accumulated signal Sₐ₃ can be determined as the accumulated signals. In some embodiments, the second accumulated signal Sₐ₂ can be determined by accumulating the target pixel signal Sₙ and the neighboring pixel signal Sₙ₊₁. The second accumulated signal Sₐ₂ can also be determined as the accumulated signal to determine whether the output condition is satisfied. Based on a determination that the accumulated signal satisfies the output condition, the second accumulated signal Sₐ₂ can also be determined as the detection result corresponding to the target pixel.

FIG. 11 shows an example apparatus 11 for processing detection result, consistent with some embodiments of this disclosure. The apparatus includes a first acquisitor unit 111 and a second acquisitor unit 112.

The first acquisitor unit 111 can determine a signal peak of a target pixel signal.

The second acquisitor unit 112 can determine an accumulated signal by accumulating the target pixel signal and the neighboring pixel signals, based on a determination that the signal peak of the target pixel signal is not greater than a first detection threshold, and the target pixel signal and neighboring pixel signals satisfy an accumulation condition.

It should be understood that each module or unit in the embodiments described in this disclosure can include one or more physical components in whole or in part. For example, a module or unit can be implemented as a processor, a controller, a computer, or any form of hardware components. As another example, a module or unit can include one or more hardware components and one or more software components. For example, the module can include a processor (e.g., a digital signal processor, microcontroller, field programmable gate array, a central processor, an application-specific integrated circuit, or the like) and a computer program, when the computer program is run on the processor, the function of the module can be realized. The computer program can be stored in a memory (e.g., a random-access memory, a flash memory, a read-only memory, a programmable read-only memory, a register, a hard disk, a removable hard disk, or a storage medium of any other form), or a server. For example, the first acquisitor unit 111 and the second acquisitor unit 112 can include a processor, such as field programmable gate array, or central processor unit.

In some embodiments, execution processes of the first acquisitor unit 111 and the second acquisitor unit 112 can correspondingly follow S301-S302, and are not described herein again.

This disclosure further provides a computer-readable storage medium. The computer-readable storage medium can be a non-volatile storage medium or a non-transient storage medium, and stores a computer program. The computer program can execute steps of the method for processing detection result provided in any one of the embodiments when executed by a processor.

This disclosure further provides another apparatus for processing detection result, including a memory and a processor. The memory stores a computer program executable on the processor. The processor can execute steps of the method for processing detection result provided in any one of the embodiments when executing the computer program.

All or some of the steps in the various methods in the embodiments can be implemented by instructing relevant hardware by a program. The program can be stored in a computer-readable storage medium. The storage medium can include an ROM, an RAM, a magnetic disk or an optical disk, or the like.

The terms “or” of this disclosure describe an association relationship between associated objects, and represent a non-exclusive inclusion. For example, “A or B” can include: only “A” exists, only “B” exists, and “A” and “B” both exist, where “A” and “B” can be singular or plural. For another example, “A, B, or C” can include: only “A” exists, only “B” exists, only “C” exists, “A” and “B” both exist, “A” and “C” both exist, “B” and “C” both exist, and “A”, “B”, and “C” all exist, where “A,” “B,” and “C” can be singular or plural. In this disclosure, the term “at least one of A or B” has a meaning equivalent to “A or B” as described above. The term “at least one of A, B, or C” has a meaning equivalent to “A, B, or C” as described above.

Although this disclosure is disclosed, this disclosure is not limited thereto. Any person skilled in the art can make various changes and modifications without departing from the spirit and scope of this disclosure.

1. A method for processing detection result, comprising:
determining a signal peak of a target pixel signal; and
determining an accumulated signal by accumulating the target pixel signal and the neighboring pixel signals, based on a determination that the target pixel signal and a neighboring pixel signal satisfy an accumulation condition and the signal peak of the target pixel signal is not greater than a first detection threshold.

2. The method of claim 1, wherein the target pixel signal and the neighboring pixel signals satisfy the accumulation condition comprising: a peak value of the target pixel signal is less than a first accumulation threshold, and a signal peak of the neighboring pixel signal is less than a second accumulation threshold; and a neighboring pixel is a pixel adjacent in angle to a target pixel, or a pixel adjacent in channel to the target pixel.

3. The method of claim 2, wherein the first accumulation threshold is configured to be a predetermined first constant value, or the first accumulation threshold is configured to be determined based on the target pixel signal; and
the second accumulation threshold is configured to be a predetermined second constant value, or the second accumulation threshold is configured to be determined based on the target pixel signal.

4. The method of claim 3, wherein the first accumulation threshold or the second accumulation threshold is configured to be determined based on the following steps:
determining a first clamped signal by clamping the target pixel signal;
determining a mean value μₙ and a standard deviation on of the first clamped signal; and
determining the first accumulation threshold as μₙ+y₁σₙ, and determining the second accumulation threshold as μₙ+y₂σₙ, and y₁≤y₂.

5. The method of claim 4, wherein the clamping the target pixel signal comprises:
comparing a signal amplitude of the target pixel signal at each time stamp with a predetermined clamp value, and selecting a minimum value between the signal amplitude at each time stamp and the predetermined clamp value, wherein the minimum value corresponding to the time stamp is configured to be a signal amplitude of the first clamped signal at a corresponding time stamp.

6. The method of claim 1, further comprising: based on a determination that the signal peak is greater than the first detection threshold, determining the target pixel signal as a detection result corresponding to a target pixel.

7. The method of claim 1 or 6, the first detection threshold is configured to be a predetermined third constant value, or the first detection threshold is configured to be determined based on the target pixel signal.

8. The method of claim 7, wherein the first detection threshold is configured to be determined based on the following steps:
determining a first clamped signal by clamping the target pixel signal;
determining a mean value μₙ and a standard deviation on of the first clamped signal; and
determining the first detection threshold to be μₙ+Xσₙ.

9. The method of claim 1, wherein when determined the accumulated signal, the method further comprising:
when detecting the accumulated signal satisfying a predetermined output condition, determining the accumulated signal as a detection result corresponding to a target pixel.

10. The method of claim 9, wherein a neighboring pixel comprises a first neighboring pixel and a second neighboring pixel; the accumulated signal comprises a first accumulated signal determined by accumulating the target pixel signal and a first neighboring pixel signal, a second accumulated signal determined by accumulating the target pixel signal and a second neighboring pixel signal, and a third accumulated signal determined by accumulating the target pixel signal, the first neighboring pixel signal, and the second neighboring pixel signal; and wherein when detecting the accumulated signal satisfying the predetermined output condition, determining the accumulated signal as the detection result corresponding to the target pixel comprising:
determining the accumulated signal satisfying the output condition as the detection result corresponding to the target pixel when detecting any one of the first accumulated signal, the second accumulated signal, and the third accumulated signal satisfying the output condition.

11. The method of claim 10, wherein when detecting the accumulated signal satisfying the predetermined output condition, determining the accumulated signal as the detection result corresponding to the target pixel comprising:
when detecting a plurality of the first accumulated signal, the second accumulated signal, and the third accumulated signal satisfying the output condition, selecting the one with the highest peak value among the first accumulated signal, the second accumulated signal, and the third accumulated signal as the detection result corresponding to the target pixel.

12. The method of claim 9-11, wherein the output condition comprising: a peak value of the accumulated signal is greater than a second detection threshold.

13. The method of claim 12, wherein the second detection threshold is configured to be a predetermined third constant value, or the second detection threshold is configured to be determined based on the accumulated signal.

14. The method of claim 13, wherein the second detection threshold is configured to be determined based on the following steps:
determining a second clamped signal by clamping the accumulated signal;
determining a mean value μ₂ and standard deviation σ₂ of the second clamped signal; and
determining the second detection threshold to be μ₂+xσ₂.

15. The method of claim 13, wherein neighboring pixels comprise a first neighboring pixel and a second neighboring pixel; and the second detection threshold is determined based on the following steps:
determining a third clamped signal by clamping the first neighboring pixel signal, and determining a fourth clamped signal by clamping the second neighboring pixel signal;
determining a mean value μₙ₋₁ and standard deviation σₙ₋₁ of the third clamped signal and a mean value μₙ₋₂ and standard deviation σₙ₋₂ of the fourth clamped signal; and
determining the second detection threshold to be μ₂+xσ₂, wherein μ₂ (μₙ₋₁+μₙ₊₁)/2, and σ₂=\sqrt{varₙ₋₁+varₙ₊₁}÷2.

16. The method of claim 13, wherein neighboring pixels comprise a first neighboring pixel and a second neighboring pixel; and the second detection threshold is configured to be determined based on the following steps:
determining a first clamped signal by clamping the target pixel signal, determining a third clamped signal by clamping the first neighboring pixel signal, and determining a fourth clamped signal by clamping the second neighboring pixel signal, respectively;
determining a mean value μₙ and standard deviation on of the first clamped signal, and determining a mean value μₙ₋₁, standard deviation σₙ₋₁, and variance varₙ₋₁ of the third clamped signal, and a mean value μₙ₊₁, standard deviation σₙ₊₁, and variance varₙ₊₁ of the fourth clamped signal; and
determining the second detection threshold to be μ₂+Xσ₂, wherein μ₂=(μₙ₋₁+μₙ+μₙ₊₁)/3, and σ₂=\sqrt{varₙ₋₁+varₙ+varₙ₊₁}÷3.

17. A detection result processing apparatus, comprising:
a first acquisitor unit, configured to determine signal peak value of target pixel signal;
a second acquisitor unit, configured to determine an accumulated signal by accumulating the target pixel signal and the neighboring pixel signals, based on a determination that the target pixel signal and a neighboring pixel signal satisfy an accumulation condition and the signal peak of the target pixel signal is not greater than a first detection threshold.

18. A computer-readable storage medium, wherein the computer-readable storage medium is a non-volatile storage medium or a non-transient storage medium, and stores a computer program, and wherein the computer program is configured to execute steps of the method for processing detection result of any of claims 1 to 16 when executed by a processor.

19. An apparatus for processing detection result, comprising a memory and a processor, wherein the memory stores a computer program executable on the processor, and wherein the processor is configured to execute steps of the method for processing detection result of any of claims 1 to 16 when executing the computer program.
